(19) United States
(12) Patent Application Publication
(10) Pub. No.: US 2008/0060399 A1
(43) Pub. Date: Mar. 13, 2008

(54) METHOD FOR REAPPEARING COMBINATION OF A COMBINATION LOCK AND THE STRUCTURE THEREOF

(75) Inventor: Miko LEE, Hsinchuang City (TW)

Correspondence Address: PATENTTM.US, P. O. BOX 82788, PORTLAND, OR, 97282-0788, US

(73) Assignee: ABA UFO INTERNATIONAL CORP., Hsin Chuang City (TW)

(21) Appl. No.: 11/531,580

(22) Filed: Sep. 13, 2006

(51) Int. Cl. E05B 37/02

(52) U.S. Cl. 70/312

(57) ABSTRACT

A structure for reappearing combination number of a combination lock includes a notch adapted to be defined in a proximal end of each sleeve, a cutout adapted to be defined in a distal end of each sleeve to be opposite to the notch, wherein the notch is mis-aligned with the cutout and at least one hole adapted to be defined in the casing to align with a corresponding one of the cutouts when the notches are in alignment.

### BACKGROUND OF THE INVENTION

1. Field of the Invention

The present invention relates to a method for reappearing combination of a combination lock, and more particularly to the method to reappear the combination of the combination lock and the structure thereof.

2. Description of the Prior Art

It is well known in the art that a combination lock depends on the combination to control movement of the latch so that the user is able to lock or unlock an object. Although there is a mechanism in most combination locks to enable the user to change the combination, often the combination is forgotten or completely lost due to long period of time lapsed without using the combination lock. In order to obviate the embarrassment, some users just write down the combination onto the body of the combination lock, which does not solve the problem, but often attracts unauthorized personnel to commit a crime.

To have a better understanding of the combination lock, reference is made to FIGS. 5 and 6. It is noted from the depiction of FIG. 5 that a conventional combination lock includes a casing (51), multiple wheels (52) rotatably received inside the casing (51) and a latch (54) operatively extending through sleeves (53) which each is movably received in a corresponding one of the wheels (52). Each of the sleeves (53) is provided with a notch (531) defined in an inner periphery defining a centrally defined through hole (not numbered) of the sleeve (53). The latch (54) is provided with multiple bosses (541) linearly formed on an outer periphery of the latch (54). Thus when only each of the notches (531) are aligned with one another, as shown in FIG. 8, can the bosses (541) of the latch (54) be moved relative to the casing (51). That is, when the user rotates the wheels (52) to rearrange the numbers on the wheels (52) until the correct combination appears, the notches (531) are aligned with one another such that the latch (54) is able to move relative to the casing (51).

Another type of conventional combination lock (6) is shown in FIGS. 6, 7A and 7B. The combination lock (6) has a casing (61), wheels (62) rotatably received in the casing (61), sleeves (63) each movably received in a corresponding one of the wheels (62) and a latch (64) linearly and movably received in the casing (61). The latch (64) has multiple projections (641) extending outward therefrom to correspond to notches (631) of the sleeves (63). Thus only when the user rotates the wheels (62) to reappear the correct combination, can the notches (631) be aligned with one another and the latch (64) moved relative to the casing (61).

From the above description, it is noted that either the latch (54) in FIG. 5 moved outside the casing (51) or the latch (64) in FIG. 6 moved inside the casing (61) requires that the notches (531,6531) be in alignment with one another to allow the latch (54,64) to move relative to the casing (51,61). In addition, as shown in FIGS. 7A and 7B, it is noted that no matter what type of combination lock is chosen, when the user is changing the combination number, the user will have to push the sleeves (53,63) away from the corresponding wheels (52,62). Then the extensions (532,632) formed on an outer periphery of the wheels (52,62) and originally received in the corresponding recesses (521,621) defined in an inner periphery of the wheels (52,62) leave the corresponding recesses (521,621) to allow the wheels (52,62) to rotate freely relative to the sleeves (52,63), which accomplish the objective of changing the combination.

Even the combination lock available on the market is convenient in use, once the combination is lost or forgotten, there is no way to retrieve the number except to sabotage the combination lock or rely on the locksmith to open the lock.

To overcome the shortcomings, the present invention tends to provide an improved combination lock to mitigate the aforementioned problems.

### SUMMARY OF THE INVENTION

The primary objective of the present invention is to provide a combination lock enabling to retrieve the originally set number so as to help the user to reopen the combination lock.

An objective of the method of the present invention for reappearing combination number of a combination lock includes:

defining at least one hole in a side face of the casing of the combination lock;

defining cutouts in distal ends of sleeves, which are opposite to notches which are defined in proximal ends of the sleeves;

selecting certain cutouts which are mis-aligned with the notches;

rotating sleeves to allow the cutout of each selected cutout to align with a corresponding one of the at least one hole; and

rearranging the notches to allow the notches to be in a linear arrangement.

A step of inserting an auxiliary tool into two mutually aligned cutout and the at least one hole so as to ensure the alignment between the at least one hole and the corresponding at least one hole is inserted between the sleeve rotating step and the notch rearrangement step.

A further objective of the present invention includes at least one bolt being received in the at least one hole when the at least one hole is not in use.

Still a further objective of the present invention is to provide a combination lock having a casing, multiple wheels rotatably received in the casing, multiple sleeves each movably received in a corresponding one of the wheels and a latch operably connected to the casing so as to move linearly relative to the casing, wherein a notch adapted to be defined in a proximal end of each sleeve, a cutout adapted to be defined in a distal end of each sleeve to be opposite to the notch, wherein the notch is mis-aligned with the cutout and at least one hole adapted to be defined in the casing to align with a corresponding one of the cutouts when the notches are in alignment.

Still another objective of the present invention is to provide an auxiliary tool extending into the at least one hole and one of the cutouts to ensure alignment between the at least one hole and a corresponding one of the cutouts.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the combination lock of the present invention;

FIG. 2 is a partially exploded perspective view of the combination lock of the present invention;

FIG. 3A is a perspective view showing the structure of the sleeves of the present invention;

FIG. 3B is a perspective view showing the structure of the sleeves different to that shown in FIG. 3A;

FIG. 4 is a perspective view showing how the combination is retrieved via an auxiliary tool which is used to extend into each and every one of the threaded holes in the casing;

FIG. 5 is a perspective view of a conventional combination lock, wherein the casing is partially removed to clearly see the internal structure of the combination lock;

FIG. 6 is a perspective view of a different conventional combination lock, wherein the casing is partially removed to clearly see the internal structure of the combination lock;

FIG. 7A is a perspective view showing the relative position of the sleeve to the wheel;

FIG. 7B is an operational view showing that the sleeve is moved away from the corresponding wheel to start combination change procedure; and

FIG. 8 is a perspective view of a series of conventional sleeves.

### DETAILED DESCRIPTION OF THE PREFERRED EMBODIMENT

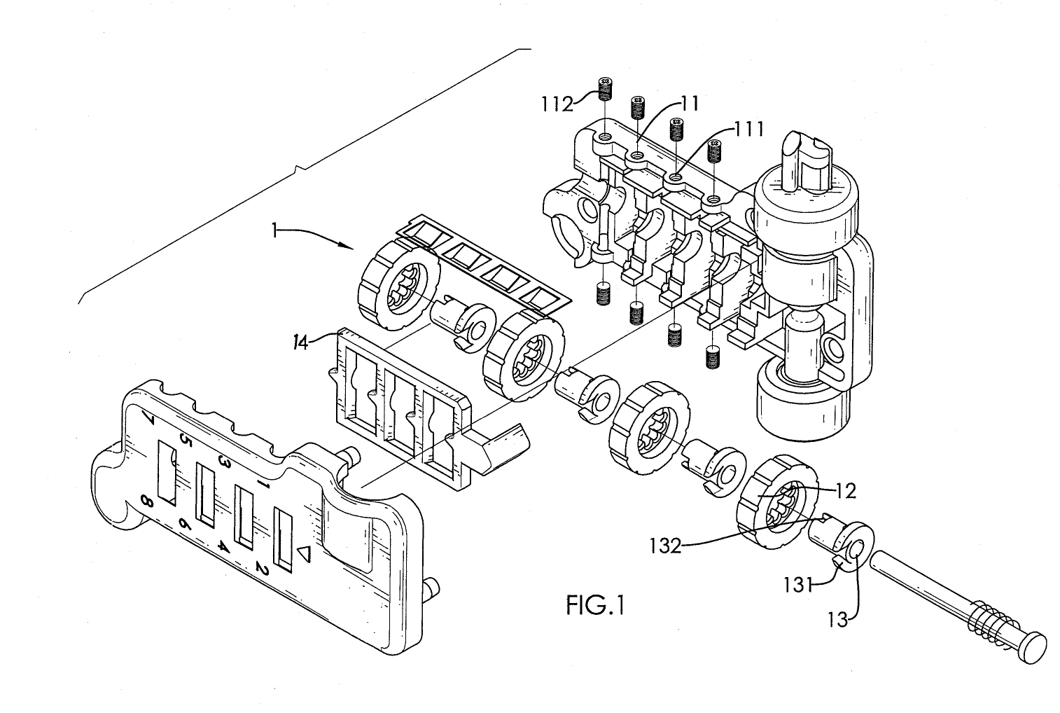

With reference to FIG. 1, it is noted that the combination lock (1) in accordance with the present invention includes a casing (11), multiple wheels (12) rotatably received inside the casing (11), sleeves (13) each movably received in a corresponding one of the wheels (12) and a latch (14) linearly movable relative to and received in the casing (11). All the elements described above are conventional in the art, details concerning the operation and associated structural relationship is thus omitted. The following description will then focused on the improvement of the present invention.

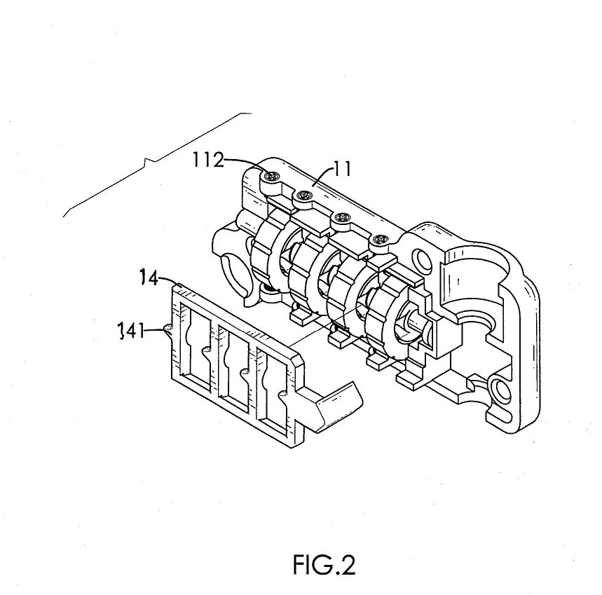

With reference to FIG. 2 and still using FIG. 1 for reference, it is noted that the casing (11) has multiple threaded holes (111) defined through a side face of the casing (11) to allow extension of threaded bolts (112). Further, each sleeve (13) has a notch (131) defined in a proximal end thereof and a cutout (132) defined in a distal end thereof. Because each of the sleeves (13) is rotatable relative to the casing (11), each cutout (132) is selectively aligned with a corresponding one of the threaded holes (111).

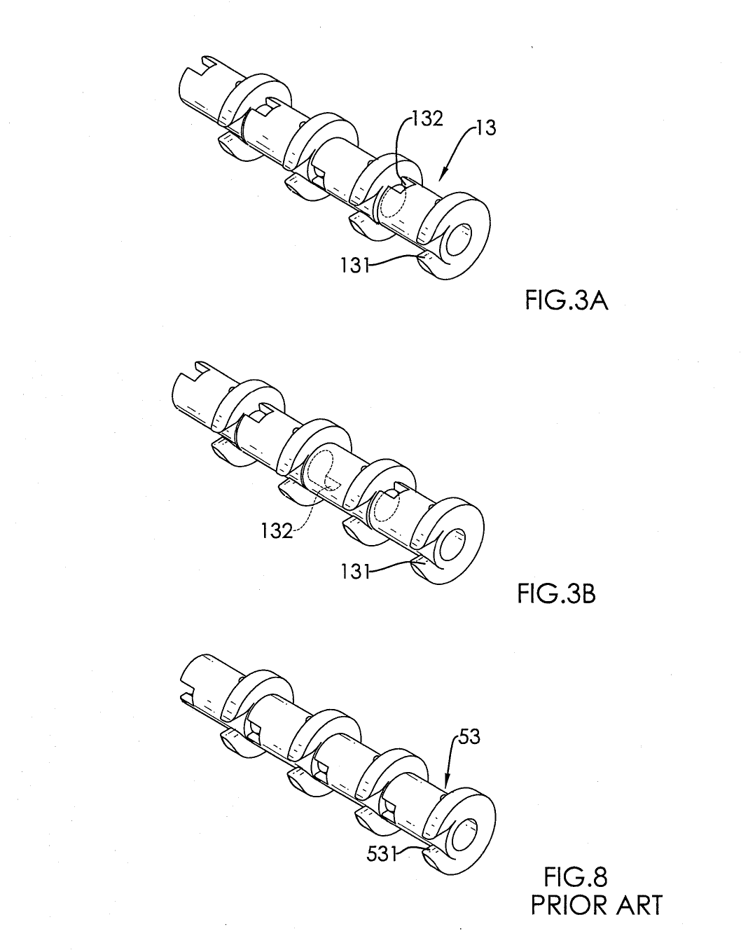

With reference to FIGS. 3A and 3B, it is noted that when the combination lock of the present invention is assembled for the very first time and in the unlocked status, positions of the sleeves (13) inside the casing (11) are fixed. That is, all the notches (131) are aligned with one another due to the movement of the latch (14). However, the positions of the cutouts (132) of the sleeves (13) are not necessary aligned with one another and with the notches (131). In other words, the manufacturer uses some (or all) of the cutouts (132) to align with some of the threaded holes (111) so as to determine a default combination for unlocking the combination lock.

There may be only one row of the threaded holes (111) defined in the side face of the casing (11) such that after the selected cutouts (132) are aligned with the threaded holes, the cutouts (132) are located at the same position. Due to the variety of selecting the cutouts (132), the sleeves (13) selected are not necessary to be close to one another.

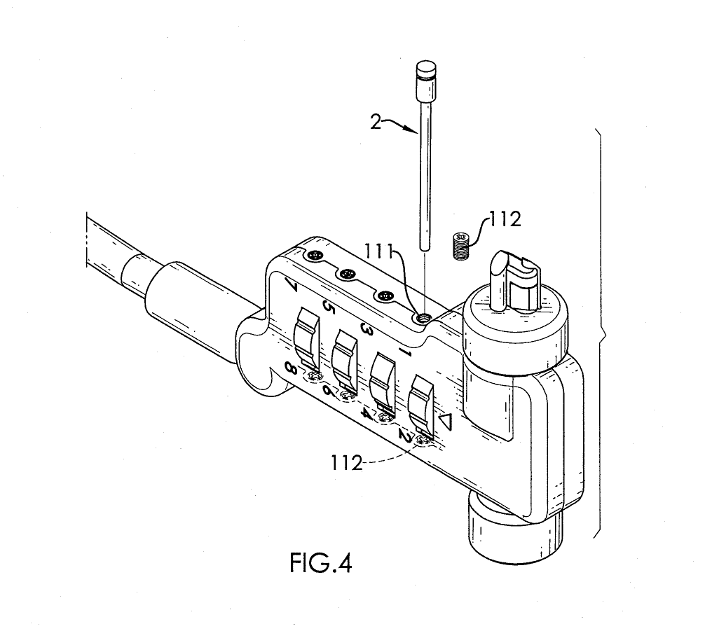

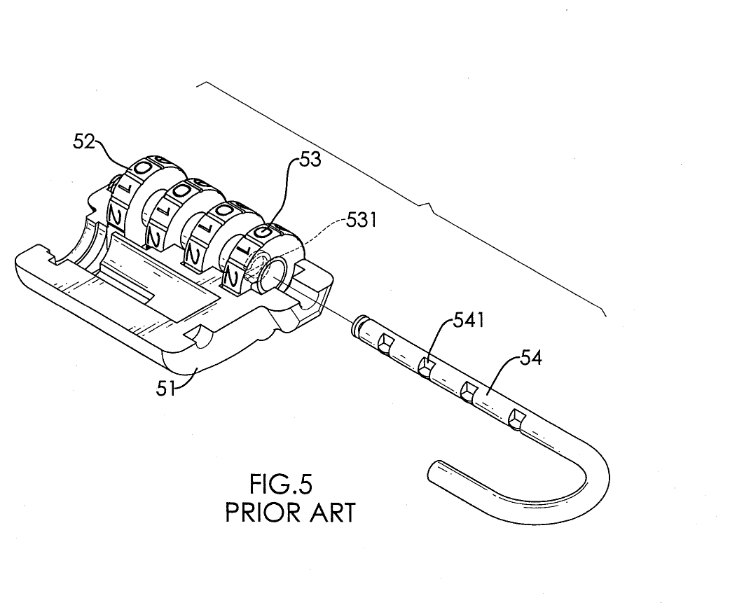

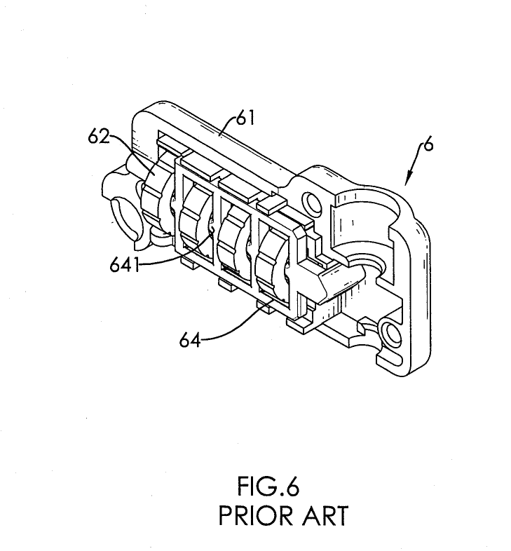

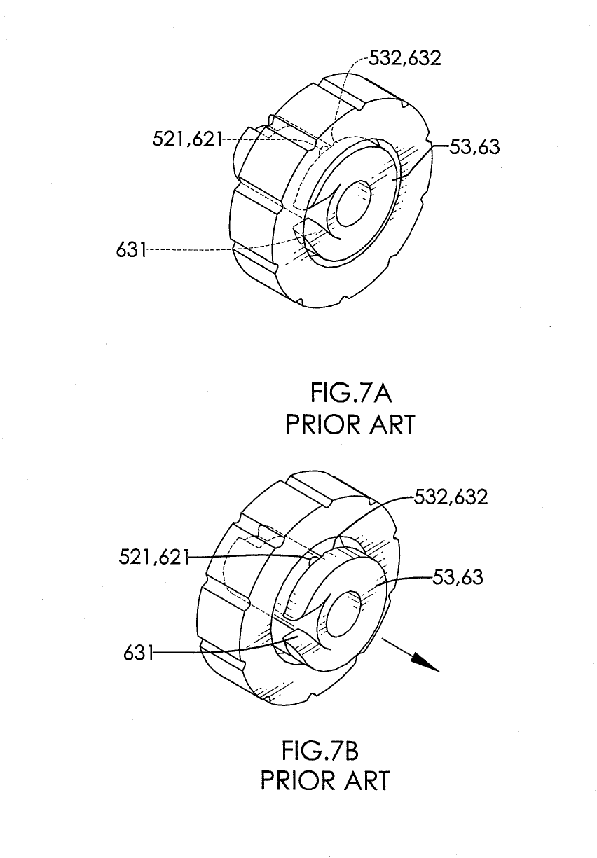

For example, if the default combination is 1, 4, 5 and 8 (as shown in FIG. 4), the selected cutouts (132) will be aligned with the corresponding threaded holes (11). The non-selected cutouts (132) are not aligned with any of the threaded holes (111).

With reference to FIG. 4, it is noted that after the combination lock is manufactured with the default combination and has been implemented for quite some time, if the self-determined combination is lost or forgotten, an auxiliary tool (2) is required to unlock the combination lock. The auxiliary tool (2) is provided with a pre-engraved default combination for a certain combination lock (e.g. 1, 4, 5 and 8).

Before proceeding with the unlocking process, the user first remove the threaded bolts (112) located at the positions corresponding to the numerals, e.g. 1, 4, 5 and 8. Then a sharp end of the auxiliary tool (2) is extended into the threaded holes (111) corresponding to the numerals 1, 4, 5 and 8. Rotating the wheels (12) to drive the sleeves (13) to rotate accordingly. When the cutout (132) of the sleeve (13) is aligned with the sharp end of the auxiliary tool (2), the sharp end of the auxiliary tool (2) is able to extend into the cutout (132). Thus the user is able to know one of the default combination. The subsequent combination will thus be obtained by repeating the same process. The number of rows of the threaded holes (111) is based on the number of the wheels (12). That is, the more the wheels (12) are, the more rows the threaded holes (111) are.

It is concluded that when the user is trying to open the combination lock of the present invention, the user will have to follow the following steps to find out what the default combination is:

defining at least one row of threaded holes in the casing of the combination lock;

defining cutouts in distal ends of sleeves, which are opposite to notches defined in proximal ends of the sleeves;

selecting certain cutouts which are mis-aligned with the notches;

rotating sleeves to allow the cutout of each selected cutouts to align with a corresponding threaded holes; and

rearranging the notches to allow the notches to be in a linear arrangement.

Furthermore, an auxiliary tool is able to extend into the aligned cutout and one of the threaded holes to ensure the alignment therebetween. A threaded bolt is threadingly received in one of the threaded holes (111) so that when the threaded holes (111) are not required, the extension of the threaded bolts (112) in the corresponding threaded holes (111) ensures that the combination lock is free from damages caused by sand, liquid and other contaminants that enter the casing to cause mechanical malfunction.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. (canceled)

2. (canceled)

3. (canceled)

4. (canceled)

5. A structure for reappearing combination number of a combination lock having a casing, multiple wheels rotatably received in the casing, multiple sleeves each movably received in a corresponding one of the wheels and a latch operably connected to the casing so as to move linearly relative to the casing and having
a top;
multiple cutouts being formed through the latch, corresponding respectively to the wheels and allowing the wheels to protrude through the latch, and each cutout having a top edge; a latching arm; and
multiple locking protrusions being formed respectively on and protruding down from the top edges of the cutouts of the latch and pressing against the wheels to hold the latch up;
the structure comprising:
a notch adapted to be defined in a proximal end of each sleeve to receive one of the locking protrusions of the latch and allow the latch to move down to make the latching arm unlatch a locking mechanism;
a cutout adapted to be defined in a distal end of each sleeve to be opposite to the notch, wherein the notch is mis-aligned with the cutout; and
at least one hole adapted to be defined in the casing to align with a corresponding one of the cutouts when the notches are in alignment.

6. The structure as claimed in claim 5, wherein
the at least one hole is a threaded hole; and
at least one threaded bolt is mounted in the threaded hole.

7. The structure as claimed in claim 5 further comprising an auxiliary tool extending into the at least one hole and one of the cutouts to ensure alignment between the at least one hole and a corresponding one of the cutouts.

8. The structure as claimed in claim 6 further comprising an auxiliary tool extending into the at least one hole and one of the cutouts to ensure alignment between the at least one hole and a corresponding one of the cutouts.

9. The structure as claimed in claim 5, wherein there is one row of holes defined in the casing.

10. The structure as claimed in claim 6, wherein there is one row of holes defined in the casing.

11. The structure as claimed in claim 5, wherein there are two rows of holes defined in the casing.

12. The structure as claimed in claim 6, wherein there are two rows of holes defined in the casing.
